(19) United States
(12) Patent Application Publication
(10) Pub. No.: US 2010/0026963 A1
(43) Pub. Date: Feb. 4, 2010

(54) OPTICAL PROJECTION GRID, SCANNING CAMERA COMPRISING AN OPTICAL PROJECTION GRID AND METHOD FOR GENERATING AN OPTICAL PROJECTION GRID

(76) Inventor: Andreas Faulstich, Schwalbach (DE)

Correspondence Address: FITZPATRICK CELLA HARPER & SCINTO, 1290 Avenue of the Americas, NEW YORK, NY, 10104-3800, US

(21) Appl. No.: 12/508,357

(22) Filed: Jul. 23, 2009

(30) Foreign Application Priority Data
Aug. 1, 2008 (DE) 10 2008 040 949.9

(51) Int. Cl. G03B 21/00; G01B 11/14

(52) U.S. Cl. 353/40; 356/616

(57) ABSTRACT

The present invention relates to an optical projection grid (1) for producing a light distribution, which projection grid (1) has a transmittance distribution, wherein the transmittance distribution is formed by subregions (2a, 2b . . . 2i) containing transparent structures (5) and opaque structures (4). A plurality of structures of each type is distributed, in particular in an incoherent and alternating manner, within a subregion (2a, 2b, 2c, 2d, 2e, 2f, 2g, 2h, and 2i) and the ratio of transparent structures (5) to opaque structures (4) within a subregion (2a, 2b . . . 2i) is adjusted such that a transmittance index (Tₐ, T_{b} . . . Tᵢ) assigned to a subregion (2a, 2b . . . 2i) is achieved at least in a statistical mean.

The present invention relates to an optical projection grid for generating a light distribution, the projection grid having a predetermined transmittance distribution. The invention further relates to a scanning camera comprising a projection grid of said type and to a method for generating a projection grid of said type.

### PRIOR ART

Optical projection grids that can be used for three-dimensional scanning of objects are known in the prior art.

DE 44 36 500 A1 discloses an optical projection grid, which has binary optical density distribution and grid stripes, which are at right angles to the projected stripe profile and whose stripe width changes periodically along its longitudinal direction and in phase with the neighboring stripes.

Furthermore, projection grids are known that are intended to generate a predetermined light distribution. For three-dimensional scanning of objects, it is recommended to use light distributions that in particular generate a stripe-shaped pattern on the object to be scanned. For this purpose, the light distribution preferably reproduces a sinusoidal brightness profile. The transmittance distribution is likewise sinusoidal depending on the position of the grid in the optical path.

Since there is great difficulty in reproducing a transmittance distribution of this type on a projection grid with genuine gray scales, the prior art usually implements the reproduction of the desired transmittance distribution as fully transparent and completely opaque stripes of variable width.

The problem in optical projection grids of the aforementioned type is that the regularly recurring transmittance distributions cause diffraction patterns which, together with the discontinuous reproduction of the predetermined transmittance distribution, result in noticeable deviations between the predetermined light distribution and the light distribution actually achieved. These deviations can be considerably detrimental to the accuracy of 3D measurements and must be carefully compensated with the aid of complex calibration procedures.

It is therefore an object of the present invention to provide an optical projection grid, a scanning camera comprising an optical projection grid, and a method for generating an optical projection grid, all of which do not suffer from the drawbacks of the prior projection grids.

### SUMMARY OF THE INVENTION

An optical projection grid of the invention for generating a light distribution comprises a transmittance distribution formed by subregions containing structures that are intrinsically transparent and opaque. A plurality of structures of each type is distributed, preferably in a substantially incoherent and alternating manner, within a subregion, the ratio of transparent to opaque structures disposed within a subregion being such that a transmittance index assigned to the subregion is achieved at least in a statistical mean.

The width of the subregions in the direction of travel of the grid can be reduced by changing the juxtaposed prior block structures into incoherent and alternating structures of the opaque and transparent types.

The expression “statistical mean” should be understood to mean a value that is obtained, unlike a constant value, as a result of a probability distribution. A constant mean can be 0.8; the statistical mean may be 0.75 or 0.81 or some other value. The invention can be executed using either a constant mean or a statistically distributed mean as the transmittance index of a subregion.

Advantageously, the transparent and opaque structures within the subregion can be randomly distributed. A periodicity of the structures can thus be avoided.

The subregions can advantageously be stripes or rectangles. The difference between stripes and rectangles consists solely in their width in the direction of travel of the grid, stripes being narrower than rectangles. These stripes or rectangles preferably extend at right angles to the direction of travel of the grid, for reasons of the measuring principle used.

The structures can advantageously comprise pixels. Various design options of the subregions become available when the structures are resolved into smallest units, referred to as pixels, which can be recorded using measuring techniques and produced by manufacturing techniques. This variety of design option can lead to the reduction or even prevention of periodically recurring subregions.

Advantageously, the transmittance distribution of the projection grid can be periodical in a direction of travel of the grid.

Advantageously, the transmittance distribution in the direction of travel of the grid can correspond to a sinusoidal distribution. Measuring methods known from the prior art can thus be readily applied, with increased accuracy.

Advantageously, the transmittance distribution in a direction of travel can correspond to a periodic sequence of Gaussian curves. Due to the possibility of a reduced width of a subregion, any other distributions can be provided. A periodic sequence of Gaussian curves, that is to say a bell distribution, has proven to be suitable.

Advantageously, the random distribution of the structures within a subregion can follow a Poisson distribution, a normal distribution or a Gaussian distribution. This means that the distribution of the alternating incoherent structures is not regular, but follows a random distribution of the type cited above. In particular, when the structures are resolved to pixels, the transparency of individual pixels can be deliberately made to follow a distribution of such type.

Advantageously, the projection grid can be composed of a plurality of tiles, in each of which an intensity distribution of the invention is present, while each tile corresponds to a full grid period or a multiple thereof. This indeed results in a periodicity due to consecutive identical tiles. Nevertheless, this structure represents an improvement since a periodicity is avoided within a tile.

Advantageously, the structures can be applied to a transparent pane by printing, etching, photographic exposure, or by the electron beam process.

Advantageously, the size of the projection grid can range from 5×5 mm to 30×30 mm and the projection grid constant can be between 7*1/cm and 20*1/cm.

The dimensions and the grid constant of the projection grid in this range of values are particularly advantageous for a scanning camera intended for scanning teeth.

Advantageously, the width of the subregions in the direction of travel of the grid can be between 1 μm and 5 μm. Brightness distributions of sufficiently fine resolution such as a sinusoidal curve or a bell curve can thus be reproduced.

Advantageously, the wavelength of an illuminating light can be between 400 nm and 900 nm.

A further object of the invention is a scanning camera for intraoral scanning, which scanning camera comprises a light source, imaging optics having a movable projection grid in the illuminating beam path and an image detector in the monitoring beam path. The accuracy thereof is improved with the aid of a projection grid of the invention as described above.

Advantageously, an evaluation unit can be provided, which is calibrated taking into account the known random distribution of the projection grid. For an accurate calibration of the evaluation unit, knowledge of the actual distribution of the projection grid is of paramount importance. However, the distribution does not affect actual measurements.

A further object of the invention is a method for generating an optical projection grid comprising a transmittance distribution. A transmittance distribution of the projection grid is selected or calculated, which transmittance distribution is divided up into subregions having a transmittance index and the subregions are provided with transparent and opaque structures, these being distributed within a subregion in random distribution.

Advantageously, a continuous transmittance distribution such as a sine function can be converted into a discrete transmittance distribution that can have a particularly fine resolution. Subregions having at most 1/10th of the width of the grid periods can be provided.

Advantageously, the ratio of transparent structures to opaque structures within a subregion can be selected such that the transmittance index relevant to the subregion is achieved.

Advantageously, the distribution of the transparent and opaque structures can be carried out with the aid of a random number generator.

Advantageously, the distribution of the structures can extend across the entire grid, that is to say, without any planned repetition. Periodicity is thus completely avoided.

Advantageously, an opaque structure can be generated when a random number assigned to the structure is greater than the transmittance index that is assigned to the subregion, optionally multiplied by a factor. This provides a simple way of generating the pattern.

Advantageously, a sinusoidal distribution or a periodic sequence of Gaussian curves can be used as the transmittance distribution.

### BRIEF DESCRIPTION OF THE DRAWINGS

The invention will now be explained with reference to the drawings, in which:

FIG. 1A shows a cutout of a projection grid of the invention;

FIG. 1B shows a detail of FIG. 1A

FIGS. 2A, B are sketches of a scanning camera of the invention and of the underlying measuring principle;

FIGS. 3A-D show a projection grid known from the prior art following a sine function (FIG. 3A) in a general view (FIG. 3B), a detailed view (FIG. 3C) and the predetermined brightness distribution (FIG. 3D);

FIG. 4 illustrates an assignment principle of a transmittance distribution of the invention;

FIG. 5 shows a distribution principle in random distribution;

FIGS. 6A-C show different transmittance distributions;

FIG. 7 shows a sinusoidal transmittance distribution extending across two periods;

FIG. 8A is an overview of the distributions shown in FIGS. 7, 8B-8D;

FIGS. 8B-D show different transmittance distributions, each extending across two periods,

FIG. 9 shows a projection composed of a plurality of tiles.

### EXEMPLARY EMBODIMENT

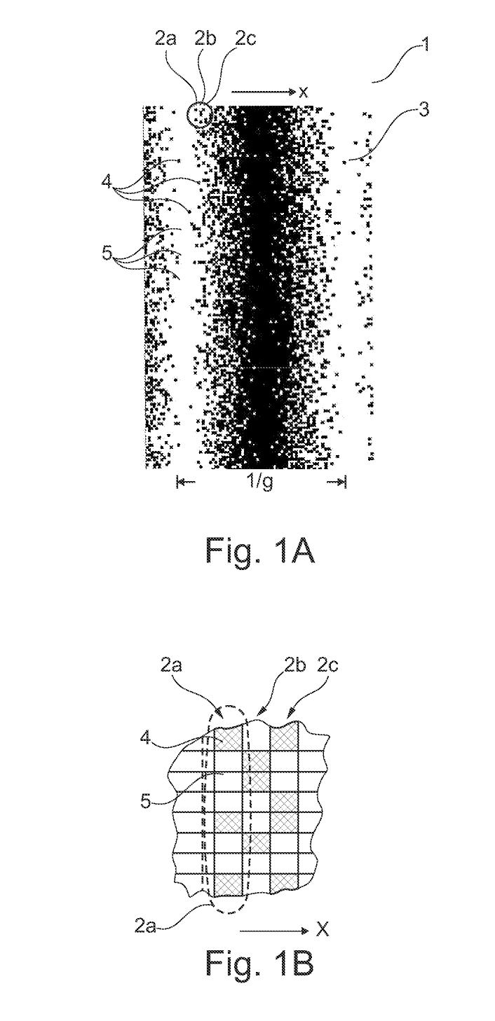

FIG. 1A is a cutout of a projection grid 1 of the invention. The cutout of the projection grid 1 illustrated shows a region of slightly more than one grid period G=1/g having a defined transmittance distribution in the direction of travel x of the grid 1, which transmittance distribution is in this case sinusoidal.

With the aid of the projection grid 1 shown in its entirety in FIG. 9, a sinusoidal brightness distribution is generated on an object to be scanned, onto which light is passed through the projection grid 1. For this purpose, the projection grid 1 is placed in a region in the optical path in which the illuminating light is widened and is substantially parallel. In a configuration of such type, that transmittance distribution on the projection grid 1 that is associated with the desired light distribution is likewise sinusoidal.

The transmittance distribution is divided up into subregions 2a, 2b . . . 2i, each subregion representing a unit that can be evaluated using measuring techniques according to the principles of stripe projection. According to the transmittance distribution shown in FIG. 1B, a subregion consists of a stripe having a width of one pixel and extending at right angles to the direction of travel x of the grid 1. The subregions 2a, 2b . . . 2i contain opaque structures 4 and transparent structures 5. In the embodiment illustrated, the structures 4, 5 are each individual pixels or groups of coherent pixels. The term “pixel” is to be understood to mean the smallest unit within a subregion that has the property of being transparent or opaque.

The ratio of transparent pixels 5 to opaque pixels 4 within a subregion 2a, 2b . . . 2i is adjusted such that a transmittance index Tₐ assigned to the subregion is obtained at least as the statistically distributed mean.

The transmittance index T is defined as the ratio of the transmitted light intensity I to the radiated light intensity I₀. Accordingly, the transmittance index is equal to the ratio of the number of transparent structures N_{T} to the total number of structures N_{T}+N₀.

Hence the ratio of the number of opaque structures N_{O} to the number of transparent structures N_{T} is given by the following equation:

$$T = \frac{{N}_{T}}{{N}_{T} + {N}_{0}}$$

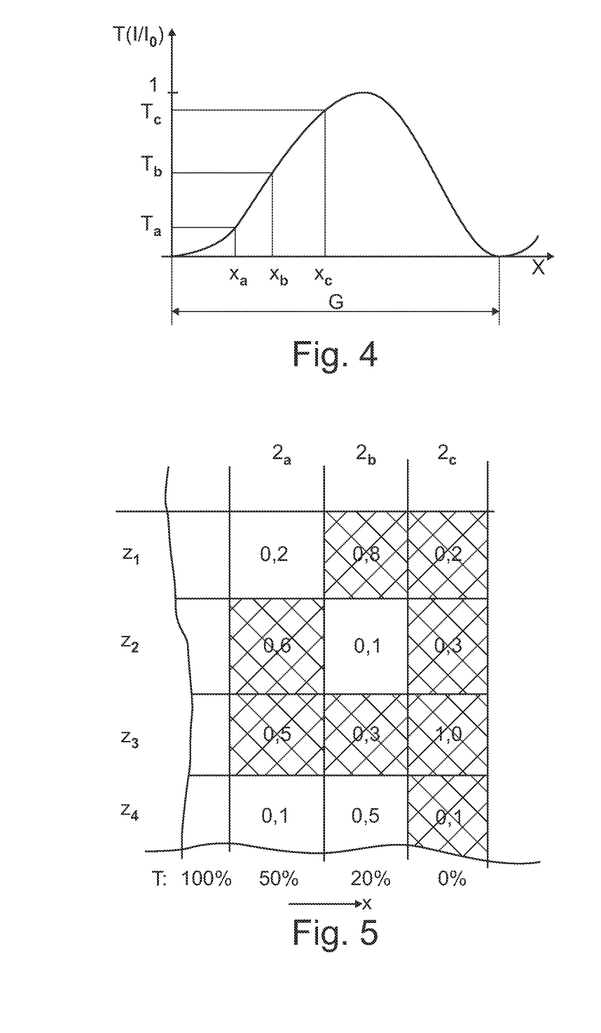

The opaque pixels 4 and the transparent pixels 5 are distributed across a subregion 2a, 2b . . . 2i in random distribution, the size of the structures composed of one or more pixels being variable. The principle of distribution is explained in more detail with reference to FIGS. 4 and 5.

Each subregion 2a, 2b . . . 2i, which is generated by means of random distribution, is unique due to the random distribution, at least within a grid period G. It is advantageous if the random distribution in the subregions extends across at least two grid periods G. This prevents the occurrence of diffraction patterns, which have a negative effect on the measurement and which would develop on the region to be scanned as a result of recurring structures.

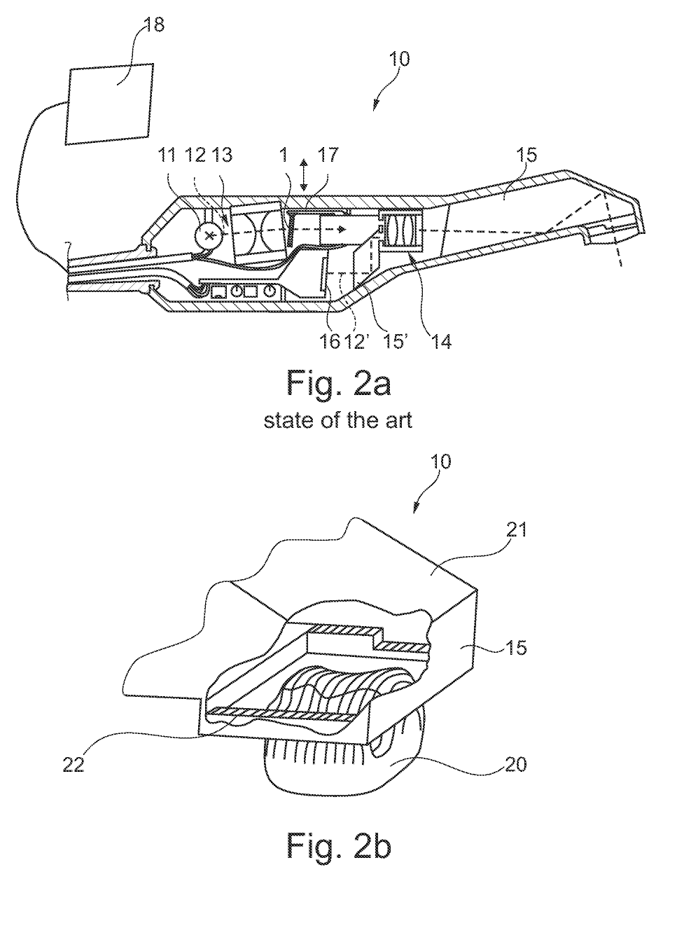

FIG. 2A is a sketch of a scanning camera and FIG. 2B shows a cutout of the camera for illustration of the underlying measuring principle for three-dimensional scanning of surfaces as are basically known in the prior art.

The projection grid 1 of the invention can be used for various known measuring principles such as phase shift triangulation, for example.

FIG. 2A is a diagram of the scanning camera 10 operating according to the principle of phase shift triangulation. The scanning camera 10 serves to scan three-dimensional objects such as teeth. The object to be scanned is not shown in the figures.

The scanning camera 10 comprises light sources 11, from which a beam 12 emanates, as shown by dashed lines. The beam 12 is widened with the aid of the lens system 13 and passes through the projection grid 1 of the invention. The light structured after passing through the projection grid 1 passes through the image-forming lens system 14 and is deflected onto the object 20 to be scanned (FIG. 2B) with the aid of a prism 15.

After being reflected by the object to be scanned, a monitoring beam 12′ that is at an angle to the illuminating beam 12 is guided back into the prism 15 and is guided through the lower part of the image-forming lens system 14. The deflecting prism 15′ deflects the monitoring beam 12′ onto an image detector 16.

The projection grid 1 is secured to a movable holder 17. The movable holder 17 serves to move the projection grid substantially transversely to the direction of the beam 12. This makes phase displacement possible.

An image is created in an evaluation unit 18 making allowance for the calibration data of the camera.

FIG. 2B illustrates the measuring principle of the scanning camera 10 with reference to a tooth 20. For this purpose, the head region 21 of the scanning camera 10 comprising the prism 15 is shown cut open. After passing through the projection grid 1, the illuminating light generates a sinusoidal brightness distribution, which, after passing through the prism 15, is projected onto the tooth 20 at a small angle to the monitoring beam path and generates on the tooth a sinusoidal brightness distribution illustrated by stripes for the sake of simplicity. When the reflection is observed at a small angle, the height profile of the tooth 20 causes deformation of the stripe pattern 22 recorded by means of the image detector 16. The surface profile of the tooth 20 to be scanned can be derived from the recorded deformed stripe pattern.

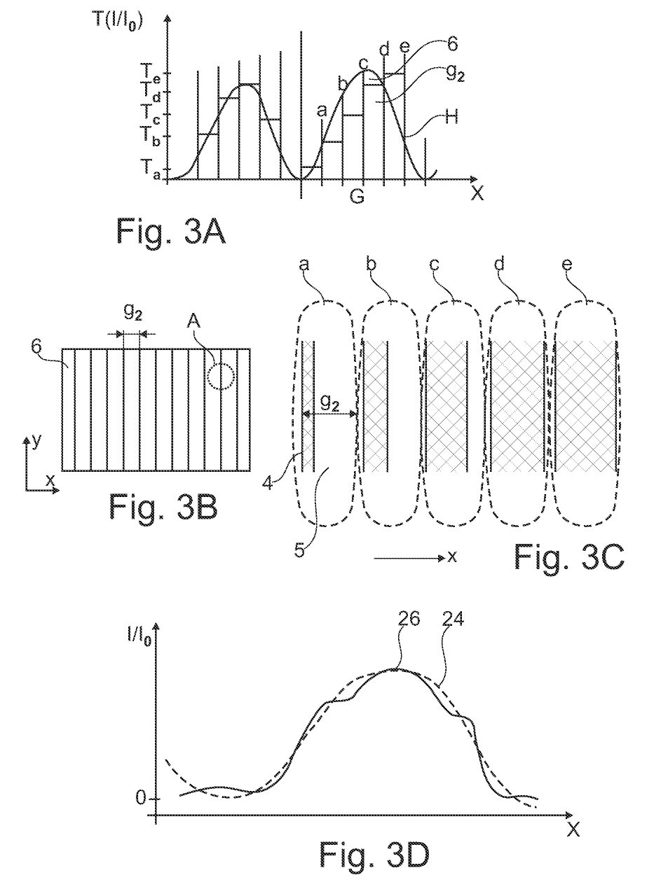

FIGS. 3A to 3D show the prior art with a predetermined brightness distribution and a projection grid in a general view and in a detailed view.

FIG. 3A shows a predetermined brightness distribution H that is to be generated with the aid of the projection grid having a grid period G on the object to be scanned. The profile in the x-direction is shown on the x-axis and the transmittance T is shown on the y-axis as the intensity I based on the intensity I₀ of the illuminating light. The illustrated profile is substantially sinusoidal in the direction of the y-axis. For determining a discrete transmittance distribution, a period of the predetermined transmittance distribution shown in FIG. 3A is divided up into sections 6a, b, c, d, and e of equal width g₂, and the transmittance Tₐ, T_{b}, T_{c}, T_{d}, and Tₑ discrete for each section is determined by taking an average of the predetermined transmittance distributions in the respective sections a, b, c, d, and e.

FIG. 3B shows diagrammatically a projection grid of the prior art for generating the brightness distribution shown in FIG. 3A. The predetermined transmittance profile is reproduced by a stripe pattern shown in detail in FIG. 3C. The projection grid comprises continuous sections 6 extending in the y direction. The sections 6 are equidistant and have a constant width g₂.

FIG. 3C shows section A from FIG. 3B as an enlargement. The predetermined transmittance distribution illustrated in FIG. 3A is reproduced by means of transparent and opaque stripes.

Sections of the projection grid having a width g₂ correspond to the sections a, b, c, d, and e shown in FIG. 3A, to which they are equal in width and are subsequently divided up into two stripes 4, 5, namely a transparent stripe 5 and an opaque stripe 4. The ratio of the width of the opaque stripe 4 to the transparent stripes 5 in the x-direction of the projection grid is such that the discrete transmittance Tₐ, T_{b}, T_{c}, T_{d}, and Tₑ required in the respective sections 6a, 6b, 6c, 6d, and 6e is achieved.

In periodic transmittance distributions as are common in three-dimensional scanning, the method described above causes a periodically recurring stripe pattern to be formed on the projection grid.

The drawback of a regular stripe pattern of this kind is that diffraction patterns are formed on the object to be scanned, these being superimposed on the predetermined brightness distribution. Another drawback is that the sections must be substantially wider than is permitted by the resolving power of the production technology used, since only then can the predetermined transmittance of a section 6 be reproduced with sufficient accuracy. The minimum width of a section 6 on the projection grid is about 20 pixels.

A measured result of a superimposition of such type is illustrated in FIG. 3D. In addition to the predetermined brightness distribution 24 indicated by dashed lines, the actual brightness distribution 26 is shown. The actual brightness distribution 26 deviates from the predetermined brightness distribution 24 in a clearly distinguishable manner. This can be attributed firstly to the division of the continuous brightness distribution into a discrete brightness distribution and secondly to diffraction effects. The deviations of the actual state from the desired state lead to a reduced measuring accuracy and may even produce measurement errors due to the evaluation unit misinterpreting the image generated.

FIG. 4 illustrates the assignment principle of the transmittance distribution of the invention.

In the case illustrated in FIG. 4, a sinusoidal transmittance distribution is intended to be achieved in the x-direction as in FIG. 3A. The sites X_{A}, X_{B}, and X_{C} correspond to subregions of the transmittance distribution that are applied to the projection grid. A defined transmittance T_{A}, T_{B}, and T_{C} is assigned to each of these sites X_{A}, X_{B}, and X_{C} via the predetermined transmittance distribution.

The difference between the case illustrated and the known method is that the distances between two coordinates of this kind can be much smaller than hitherto possible. This is achieved by virtue of the fact that the desired transmittance can be adjusted even in a subregion having a width of only one pixel. This results in an improvement in resolution over that achieved in the prior art by a factor of about 20.

FIG. 5 shows the distribution principle of the transparent and opaque structures 2a, 2b and 2c on the projection grid.

A transmittance of 50% and 20% is assigned to subregions 2a and 2b respectively and a transmittance of 0% is assigned to the subregion 2c. The large differences between the transmittance indices of the adjacent subregions 2a, 2b, and 2c serve merely as an example. In an actual embodiment, the gradation between the adjacent subregions is much smaller.

Random numbers ranging, for example, between 0 and 1 are generated with the aid of a random number generator. The distribution of the random numbers can correspond to a Poisson distribution. The transmittance index demanded for the subregion is adjusted in the direction extending at right angles to the direction of travel x by an arrangement of opaque and transparent structures depending on the random numbers. The random distribution is effected across each individual subregion, and it is also feasible to use such a distribution across the entire grid.

When the distribution is effected across the entire grid, a more homogeneous random distribution is ensured than in the case of a distribution effected only within a subregion.

Since the transmittance, like the random numbers, can assume dimensionless values between 0 and 1, a direct assignment of random numbers to the transmittance can be effected. In the case of other scales, it may be necessary to adapt the two scales to one another.

An opaque structure is generated, for example, when the random number is larger than or equal to the transmittance T of the subregion 2a-2c. Should the random value 0.6 be assigned to the subregion 2a, line Z2, for example, the corresponding structure will be opaque, since the random value 0.6 is greater than the transmittance of the subregion 2a of 50% or 0.5. The value 0.2 is assigned in the same subregion 2a to line Z1, for which reason this pixel is transparent. The distribution of structures within each of the subregions 2a to 2c requires a transformation of the random numbers such that these random numbers yield the required transmittance, at least as a statistically distributed mean, that is about 50% for the subregion 2a.

Other possible random distributions for the random numbers can be a normal distribution or a Gaussian distribution.

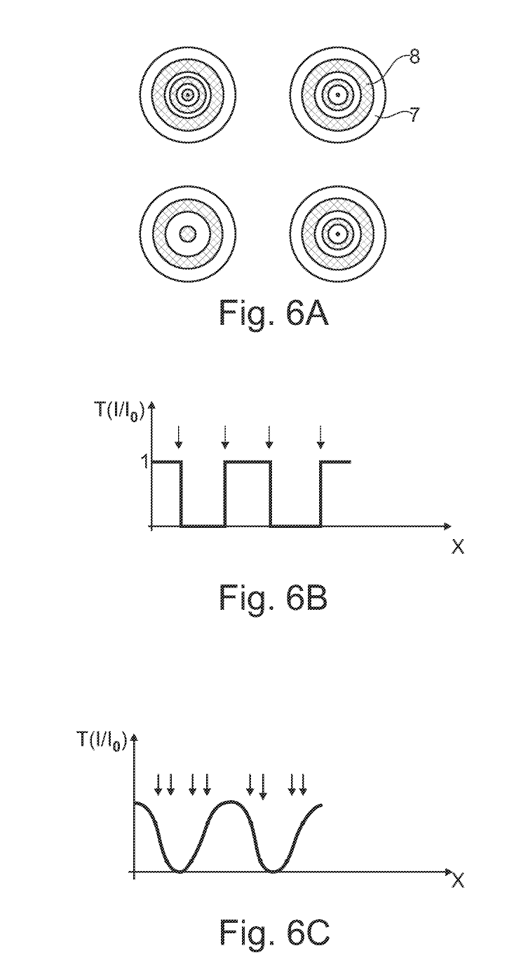

FIGS. 6A to 6C show various other possible transmittance distributions.

FIG. 6A shows, for example, a brightness distribution in which Gaussian brightness profiles 7 are distributed two-dimensionally across the grid at regular intervals. The Gaussian distributions 7 can be radially symmetrical in the plane of the projection grid, as illustrated. Subregions 8 of equal transmittance are then round.

The advantage of Gaussian transmittance distributions is that the Fourier transformation is likewise Gaussian. A Gaussian brightness distribution therefore has good imaging properties. A projection grid of this kind can therefore be used inside the scanning camera for a greater variety of applications.

FIG. 6B shows a rectangular transmittance distribution in the x-direction and a constant brightness distribution into the plane of the drawing. A rectangular brightness distribution makes it possible to record a measuring point on all sides, illustrated by arrows. However, the drawback of rectangular transmittance distributions is that they cause particularly marked diffraction patterns, since the transmittance distribution shows pronounced regularity.

FIG. 6C shows the preferred sinusoidal brightness distribution, in which case measurement is possible at two points on each of the ascending and descending slopes. The sinusoidal brightness distribution can therefore double the resolution as compared with the distribution shown in FIG. 6B. Sinusoidal brightness distributions are therefore particularly well suited for three-dimensional scanning.

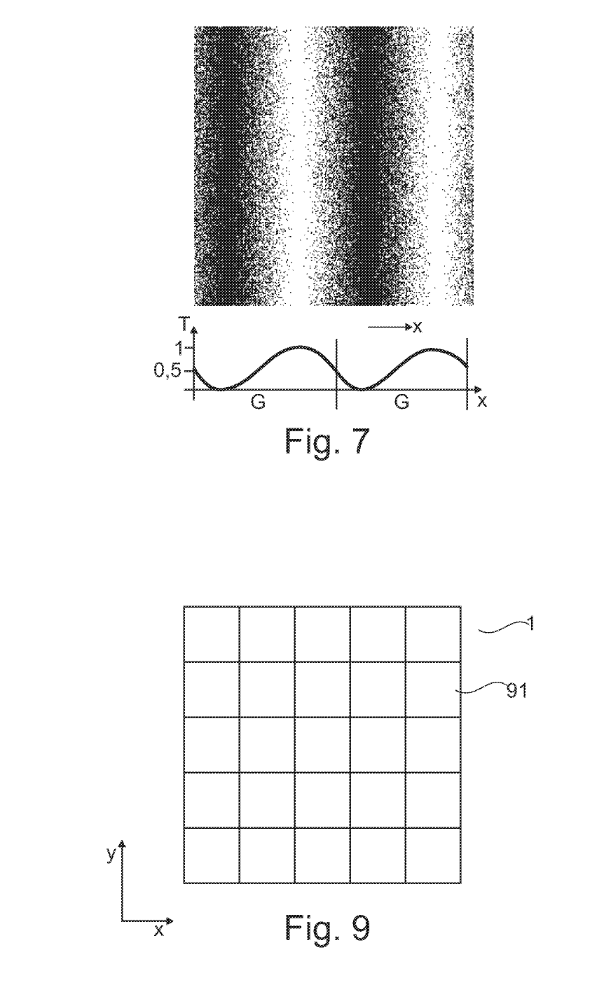

FIG. 7 shows a cutout of a projection grid having a sinusoidal brightness distribution, which cutout extends across two grid periods G. The dark points are opaque structures and the light regions represent transparent structures. When viewed in the direction of travel of the grid, the transmittance of a period starts at a value of 0.5, drops to 0, rises to 1 and then drops again to 0.5.

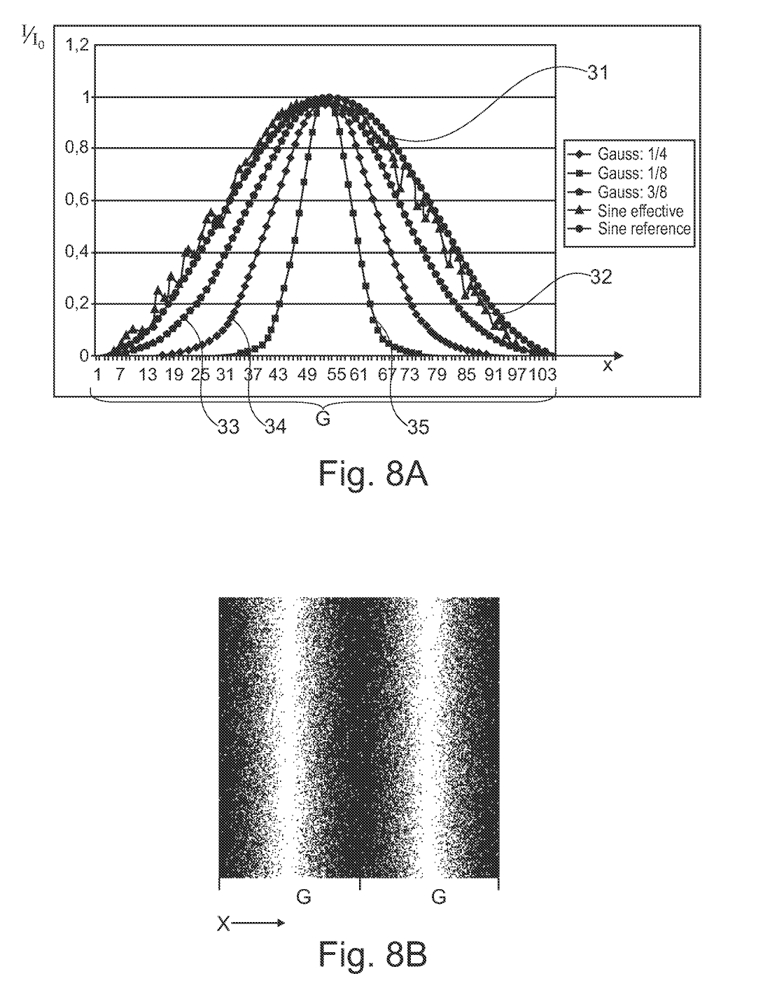

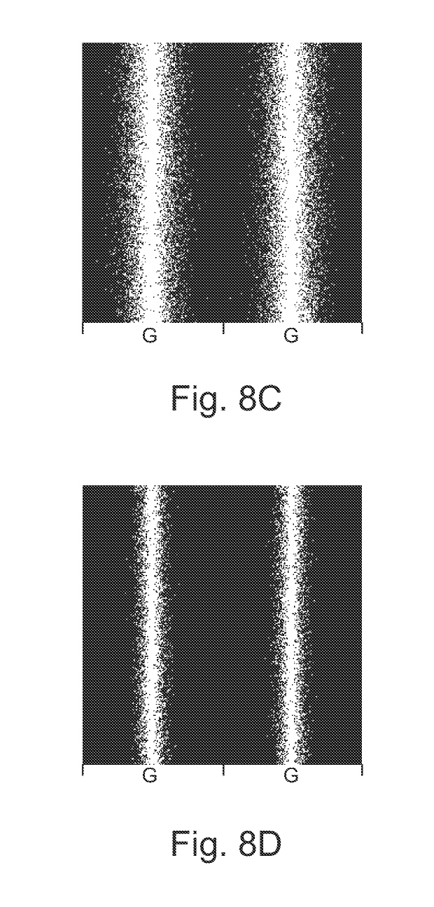

FIG. 8A shows various transmittance profiles. The outermost curve 31 corresponds to a theoretical sinusoidal profile. The immediately adjacent curve 32 is the actual profile in a projection grid of the invention with a random distribution for a sinusoidal profile. The profiles of the three inner curves 23 to 25 correspond to a Gaussian curve, also referred to as a bell curve, each showing increasing reduction in width.

FIGS. 8B-8D show different profiles of transmittance and the grids associated therewith. In FIG. 8B, the transmittance profile corresponds to a Gaussian curve with a ⅜th distribution, again illustrating two periods. Viewed in the direction of travel x of the grid, the transmittance starts from a value 0 and rises to a maximum value 1, illustrated by the light stripes, and the transmittance then again drops to the value 0. This profile is also repeated over the second period.

This structure is basically retained in FIGS. 8C and 8D, the width of the light regions in FIG. 8C being less than in FIG. 8B and the width of the light regions in FIG. 8D being less than in FIG. 8C.

FIG. 9 shows a projection grid 1 composed of a plurality of tiles 91. Each tile has a transmittance distribution extending across at least two grid periods, each of the several tiles being intrinsically identical.

The advantage of dividing the projection grid into recurring regions is that the existing production method for the grid can also be used in the hitherto used manufacturing technology involving juxtaposition of the structures in the method for producing the grid. For this purpose, an illuminator has hitherto been used that has a narrowly restricted storage capacity for the pattern of the grid to be produced.

However, it has been seen that the division of the projection grid into tiles results in an improvement over a purely conventional stripe projection, in spite of an existing periodicity.

1. An optical projection grid for producing a light distribution, which projection grid has a transmittance distribution, wherein the transmittance distribution is in the form of subregions containing transparent structures and opaque structures, wherein a plurality of structures of each type is distributed within a subregion and the ratio of transparent structures to opaque structures within a subregion is adjusted such that a transmittance index assigned to a subregion is achieved at least in a statistical mean.

2. The optical projection grid as defined in claim 1, wherein said transparent structures and said opaque structures within said subregion are distributed in random distribution.

3. The optical projection grid as defined in claim 1, wherein said subregions are stripes or rectangles.

4. The optical projection grid as defined in claim 1, wherein said structures have pixels.

5. The optical projection grid as defined in claim 1, wherein said transmittance distribution of said projection grid is periodical in a direction of travel.

6. The optical projection grid as defined in claim 1, wherein said transmittance distribution corresponds to a sinusoidal distribution in a direction of travel.

7. The optical projection grid as defined in claim 1, wherein said transmittance distribution corresponds to a periodic series of Gaussian curves in a direction of travel.

8. The optical projection grid as defined in claim 2, wherein said random distribution is a Poisson distribution, a normal distribution or a Gaussian distribution.

9. The optical projection grid as defined in claim 1, wherein said projection grid is composed of a plurality of tiles, and within each tile there is present an intensity distribution as defined in claim 1 and each tile corresponds to a complete grid period or a multiple thereof.

10. The optical projection grid as defined in claim 1, wherein said structures are produced on a transparent pane by printing, etching, photographic exposure, or by means of the electron beam process.

11. The optical projection grid as defined in claim 1, wherein the size of said projection grid ranges from 5×5 mm to 30×30 mm.

12. The optical projection grid as defined in claim 1, wherein the projection grid constant (g) ranges from 7*1/cm to 20*1/cm.

13. The optical projection grid as defined in claim 1, wherein the width of subregions in the direction of travel is between 1 μm and 5 μm.

14. The optical projection grid as defined in claim 1, wherein a wavelength of illuminating light is between 400 nm and 900 nm.

15. A scanning camera for intraoral scanning, comprising a light source, imaging optics including a movable projection grid in the optical path of the illuminating beam and including an image detector in the monitoring beam path, wherein said projection grid is designed as defined in claim 1.

16. The scanning camera as defined in claim 15, wherein an evaluation unit is provided that is calibrated taking into consideration a known random distribution of said projection grid.

17. A method for producing an optical projection grid, wherein said projection grid has a transmittance distribution, wherein
a transmittance distribution of the projection grid is selected or calculated,
the transmittance distribution is divided into subregions having a transmittance index and
the subregions are provided with transparent structures and opaque structures, said transparent structures and opaque structures being distributed within said subregion in random distribution.

18. The method as defined in claim 17, wherein a continuous transmittance distribution is converted to a discrete transmittance distribution.

19. The method as defined in claim 17, wherein the ratio of transparent structures to opaque structures within a subregion is adjusted such that the transmittance index assigned to said subregion is achieved.

20. The method as defined in claim 17, wherein the distribution of said transparent and opaque structures is generated by means of a random number generator.

21. The method as defined in claim 20, wherein the distribution of said structures extends across the entire grid.

22. The method as defined in claim 17, wherein an opaque structure is produced when a random number assigned to said structure is greater than the transmittance index assigned to said subregion optionally multiplied by a factor.

23. The method as defined in claim 17, wherein the transmittance distribution used is a sinusoidal distribution or a periodic series of Gaussian curves.
